(19) United States
(12) Patent Application Publication
(10) Pub. No.: US 2014/0340732 A1
(43) Pub. Date: Nov. 20, 2014

(54) A PLANAR OPTICAL COMPONENT AND ITS DESIGN METHOD

(71) Applicants: Yan Zhang, Beijing (CN); Dan Hu, Beijing (CN)

(72) Inventors: Yan Zhang, Beijing (CN); Dan Hu, Beijing (CN)

(73) Assignee: Capital Normal University, Beijing (CN)

(21) Appl. No.: 13/978,100

(22) PCT Filed: Apr. 12, 2012
(86) PCT No.: PCT/CN2012/073925

§ 371 Date: Jul. 3, 2014

(30) Foreign Application Priority Data
Mar. 28, 2012 (CN) 201210086716.9

(51) Int. Cl. G02F 1/01; G06F 17/50

(52) U.S. Cl. CPC G02F 1/01; G06F 17/50
USPC 359/279; 703/1

(57) ABSTRACT

This invention relates to a planar optical component and a design method thereof, the method including designing a structure with defined discrete phases; based on the structure with defined discrete phases as array elements, designing a 2D thin antenna array; constituting the planar optical component by a metal film having the 2D thin antenna array and a substrate. To achieve expected beam shaping effect, the method according to the embodiment of the present invention modulates structural parameters of antenna array elements to modulate the amplitude and phase of radiation field having vertical polarization states, which is excited by a beam having specific wavelengths and polarization states incident on the planar diffractive optical component. The planar diffractive optical component according to the embodiment of the present invention has little difference from expected parameters, and can achieve optimum beam shaping effect to make up the shortfall of conventional beam shaping elements.

### TECHNICAL FIELD

The present invention relates to the field of optics, and more specifically to a planar optical component and its design method.

### BACKGROUND

Traditional optical devices rely on gradual phase shifts accumulated during light propagation to achieve beam shaping. New degree of freedom in beam shaping could be obtained by introducing abrupt phase changes over the scale of the wavelength. An abrupt phase shift can be achieved by suitably engineering the interface between two different media. The phase discontinuity in the process of light propagation can be studied when the beam propagates across the interface of an optical resonator array having spacially varying phase response and sub wavelength interval. Equal amplitude conditions for the beam spreading along the interface and thus a constant phase gradient can be obtained by suitably designing the optical resonator. In the optical resonator, the phase shifts between outgoing light and the incident light may change appropriately across the resonance By spatially adjusting geometry of the resonator in the thin array, frequency response of the thin array may be modulated. By designing the phase discontinuity along the interface in any manner, the wavefront of reflected light beams and refracted beams can be reset. The resonator can be an electromagnetic cavity, nano-particle clusters and plasma antenna. The plasma antennas has a great optical tunability and could be easily manufactured into planar antenna of thickness in nanometer.

Based on this mechanism, an optically thin array, which is made up of metal antennas and has linear phase variation along an interface, can be manufactured on the silicon substrate. Anomalous reflection and anomalous refraction phenomena could be observed in such optically thin array of metal antennas, which are in agreement with the generalized laws derived from Fermat's principle. It can be clearly seen that phase discontinuity offers great flexibility to beam shaping, and desired effects can thus be achieved.

Currently, it's only limited applications that phase discontinuity is applied for beam shaping, let alone in the design of optical components.

### SUMMARY OF THE INVENTION

The purpose of the present invention is to design a specific structure of the optical component by using phase discontinuity, so as to achieve expected beam shaping effects.

To achieve the above object, an embodiment of the invention provides a planar optical component for full-band beam shaping. The planar optical component comprises:

a substrate;

a metal film, setting on the substrate and having a 2D thin antenna array, which has a plurality of antenna array elements.

Preferably, the planar optical component could be used to implement beam shaping of spherical lens, spherical mirror, cylindrical lens and cylindrical mirror.

Further preferably, the antenna elements are slits and good conductors are set between adjacent slits; alternatively, antenna array elements are made of good conductor and air gaps are formed between antenna array elements.

Preferably, the antenna array component has a V-shaped structure or a rectangular structure having openings.

The embodiment of the invention also provides a design method of planar optical component. The method comprises: designing a set of structures having defined discrete phases; designing 2D thin antenna arrays, using the set of structures having defined discrete phases as array elements; the planer optical component is made up of a metal film having 2D thin antenna arrays and a substrate.

Preferably, the concrete step of designing a set of structure having defined discrete phases comprises designing variable structural parameters of the antenna according to wavelength, polarization direction of incident light and fixed structural parameters of the antenna, selecting a suitable structure based on characteristics of preset radiation field.

Preferably, said set of structure having defined discrete phases excites a radiation field having a polarization state perpendicular to direction of polarization of the incident light and having equal amplitudes and equal phase intervals.

Preferably, the step of designing a 2D thin antenna array using the set of structure having defined discrete phases as array elements comprises presetting type and related parameters of the planar optical component, presetting shape and sizes of the 2D thin antenna arrays and designing configuration of 2D thin antenna arrays.

The embodiment of the present invention achieves expected beam shaping effect by modulating the structural parameter of array element and further modulating the amplitude and phase of radiation field with vertical polarization states, which is excited by a beam having specific wavelength and polarization states incident on the planar diffractive optical component. The planar diffractive optical component has little difference from excepted parameter, which can achieve optimum beam shaping effects to make up the shortfall.

### BRIEF DESCRIPTION OF DRAWING

FIG. 1 is a diagram for showing partial structure of planar optical component according to an embodiment of the invention;

FIG. 2 is a diagram for showing that V-shaped antenna array element excites electric field according to an embodiment of the invention;

FIG. 3 is a diagram for showing that antenna array element of rectangular structure with openings excites electric field according to another embodiment of the invention;

FIG. 4 is a diagram for showing a transient amplitude spectrum of vertically polarized transmission field excited by planar optical component according to an embodiment of the invention.

### DESCRIPTION OF EMBODIMENTS

Embodiments of the present invention will be hereinafter explained in details with reference to the drawings.

The embodiments of the present invention design planar optical components having thin antenna array of a particular structure, thus achieving optimum beam shaping.

### Embodiment 1

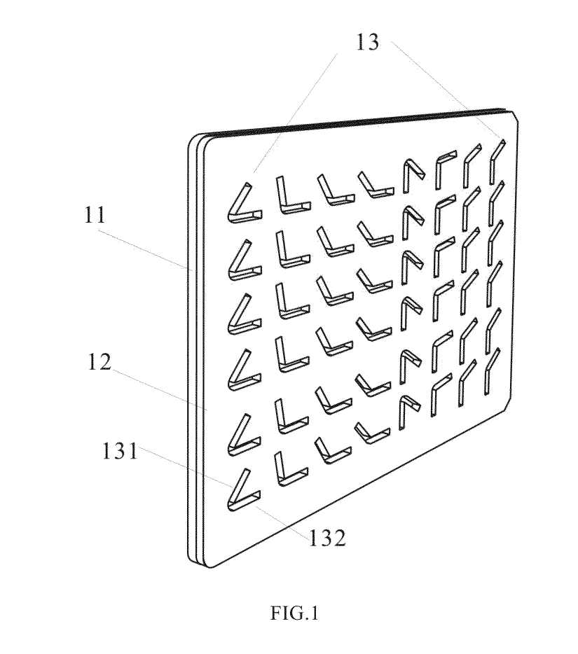

FIG. 1 is a diagram for showing the partial structure of the planar diffraction optical component which could be used to implement in full band beam shaping of spherical lens, spherical mirror, cylindrical lens, cylindrical mirror and other type of optical components.

As show in FIG. 1, the planar optical component comprises a substrate 11 and a metal film 12. The substrate 11 is made of a material having a high transmittance in optical wave band of interest, and has a thickness in the range of 300 μm˜1000 μm. The metal film 12 could use good conductor such as noble metal, for example gold, silver, copper and aluminum, with the thickness in the range of 100 nm˜1000 nm. The metal film 12 is set up on the substrate 11 and thus forming an interface with the substrate 11. A 2D thin antenna array 13 is set up on the metal film 12 and could be square array, circular array or other shapes array. The size of the thin array depends on the size of the incident light spot. The 2D thin antenna array 13 contains N antenna array elements, in which N≧16. The size of the interval between adjacent antenna elements is sub wavelength. The antenna elements are slits, good conductor being arranged between adjacent slits; Alternatively, the antenna array elements are made of good conductor, air gap being arranged between adjacent antenna array elements. When the above two corresponding antenna arrays have same structures of antenna elements and same arrangement of antenna elements in the array, one array is referred to as the anti-structure antenna array to the other one. Every antenna array element could be V-shaped structure, rectangular structure having opening or other structures. In an embodiment, the antenna array element is a V-shaped slit structure, having two arms 131 and 132 of equal length. The length h of arms is in range of 70 μm˜180 μm and the width L of arms is in range of 4 μm˜6 μm; wherein one end of the arm 131 and one end of arm 132 are connected, forming an angle Δ between the arms, which is in range of 30°˜180°.

Preferably, in an embodiment, the substrate 11 is made of silicon semiconductor and has a thickness of 500 μm; the metal film 12 is made of gold material and has a thickness of 200 nm; the metal film 12 has a 2D antenna array 13 having a size of 40*40 elements. Each of the V-shaped antenna array elements has two arms, each of which has a width of 5 μm and a arm length h, and the two arms of each antenna array element form an angle Δ; there may have four different sets values of h and Δ; the spacing between the adjacent antenna elements has a width of 200 μm.

The planar optical component according to an embodiment of the invention is based on a theory on the phase discontinuity generated from abnormal reflection phenomena and abnormal refraction phenomena. When light beam having a specific wavelength and a specific polarization state is incident on the planar optical component, a radiation field having a vertical polarization state, specific amplitude and specific phase can be excited. Specific theoretical analysis is as follows:

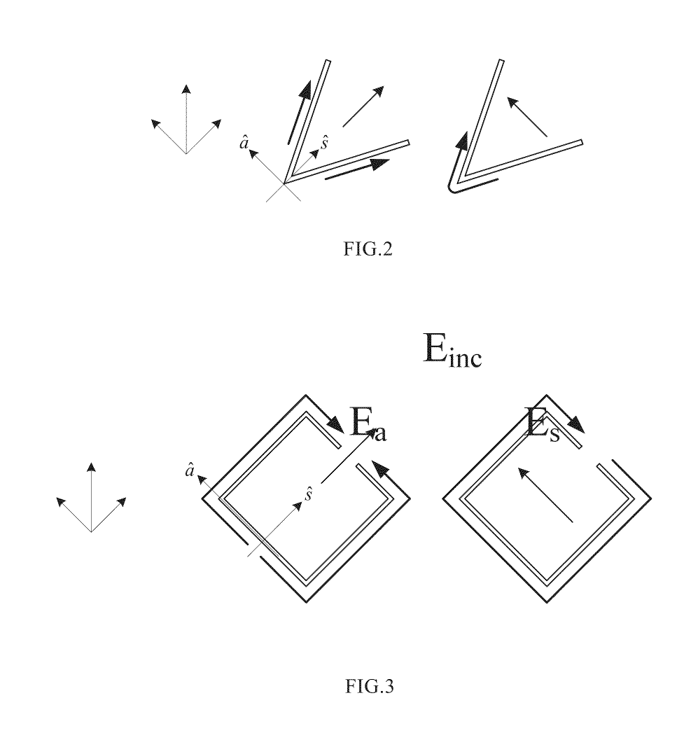

FIG. 2 shows that the V-shaped antenna array element according to an embodiment of the invention excites electric field. As shown in FIG. 2, two unit vectors are defined to describe directions of the V shaped antenna; wherein, vector ŝ has a direction along the symmetry axis of the antenna and vector â has a direction perpendicular to the symmetry axis of the antenna, i.e., perpendicular to vector ŝ. Assuming a beam light transmits through the substrate 11 and is incident on the interface at a certain angle, the beam light will radiate out after refraction or reflection. The beam light could be of any wavelength, such as visible light, infrared light or terahertz light. In an embodiment, the incident light is terahertz wave with a wavelength of 400 μm. As shown in FIG. 2, E_{inc} is the direction of polarization of the incident light, which forms certain angle with the unit vector ŝ and â, respectively. Therefore, E_{inc} can be resolved along the unit vector ŝ and â into two electric field components Eₛ and Eₐ, which are in two polarization directions, respectively. So, the electric field excited by V-shaped antenna can have two modes, one being symmetric mode and the other anti-symmetric mode. Wherein, the symmetric mode is excited by Eₛ which is a component of the incident electric field in the direction of ŝ; the anti-symmetric mode is excited by Eₐ which is a component of the incident electric field in the direction of â. Furthermore, as shown in the arrow direction, in the excited electric field of symmetric mode, the current flows along the V-shaped antenna from their connecting end to their own other end of the same and respective arm; the current distribution of each arm approximates that of an individual straight antenna with a length of h; thus the first-order resonance of the antenna occurs at h≈λ_{eff}/2, wherein λ_{eff} is the effective wavelength of the incident light. In the anti-symmetric mode of the electric field, the current flows from one arm of the V-shaped antenna to the other along the direction of Eₐ; the current distribution approximates that one generated by an individual straight antenna having a length of 2h, and the first-order antenna resonance occurs at 2h≈λ_{eff}/2.

### Embodiment 2

FIG. 3 shows electrical field excited by an antenna array element of rectangular structure having an opening according to another embodiment of the present invention. The embodiment of the invention defines two unit vectors, vector â and vector ŝ, to describe directions of the V-shaped antenna, the direction of vector ŝ being along symmetry axis of the antenna and the direction of vector â being perpendicular to the symmetry axis of the antenna, i.e., perpendicular to vector ŝ. As shown in FIG. 3, when the polarized light is incident on the antenna array element at a certain angle, the radiation field having electric fields of two mode, one being symmetric mode and the other being anti-symmetric mode, may be excited. In the electric field of symmetric mode, the current flows from the bottom of the rectangular antenna along both sides to the opening in the direction shown by the arrow; assuming that the rectangular antenna has a perimeter of 2h, the current distribution on each side of the antenna approximates that of an individual straight antenna having a length of h and the first-order antenna resonance occurs at h≈λ_{eff}/2. In the electric field of anti-symmetric mode, the current flows along the rectangular antenna for a circle from one port of the antenna to the other one; the current distribution is similar to that of a individual straight antenna with a length of 2h and the first-order antenna resonance occurs at h≈λ_{eff}/2.

As described above, when the polarization of the incident light is along the unit vector ŝ or â, the radiation field excited by each antenna array element has the same direction of polarization as the incident light, that is to say when the polarization of incident light is along the direction of the vector ŝ, electric field of symmetric mode can be excited; when the polarization of incident light is along the direction of the vector â, the anti-symmetric mode of electric filed will be excited; when the polarization of the incident light is along any other direction except the above-mentioned cases, the electric fields of these two modes can be excited. The amplitudes and phases for the electric fields of each mode may be different due to the fact that different resonance conditions are required for exciting electric fields of the two modes, respectively.

Preferably, the angles between the unit vectors ŝ, â of the antenna array element and the polarization direction of the incident light are both 45°, hence the electric field components of the incident light respectively along the directions of unit vectors ŝ and â are equal, therefore the radiation fields of symmetric mode and anti symmetric mode as excited are equal in amplitude.

As shown in FIG. 1, the 2D thin antenna array of the planar optical component contains four kinds of V-shaped antenna array elements with different angles and arms lengths. These four kinds of V-shaped antennas and their respective mirror structures can be used to excite eight kinds of the corresponding radiation fields with the same amplitude and a phase difference of π/4 therebetween. Said mirror structure refers to the symmetric structure which mirrors the surface perpendicular to the direction of polarization of the incident light of a respective one of the four kinds of V-shaped antenna. These 8 kinds of V-shaped antennas are detuned from the modes near the resonance peaks, and can be used to excite radiation fields with the same and large amplitude, thereby obtaining a high intensity of radiation field.

In the above described embodiment of the present invention, the 2D thin antenna array could have different array shapes, such as circular array and square array. As shown in FIG. 1, the planar optical component may be a square 2D thin antenna array, which may contain 40*40 V-shaped antenna array elements; each of the V-shaped antenna array elements may be chosen from the eight kinds of the V-shaped antennas as described above. The 40*40 V-shaped antenna array elements may be arranged in specific combinations as shown in the FIG. 1, and the spacing between two adjacent antenna array elements may be sub wavelength, for example 200 μm in present embodiment. On one hand, it is advantageous for each antenna array element to excite radiation field effectively, avoid generating grating diffraction; on the other hand, the amplitude and phase of the expected radiation field may be kept unaffected from the coupling between strong near-radiation field produced by adjacent antenna array elements.

As described above, the antenna array elements will generate transmitted field when the antenna array elements are formed by slits and good conductor are formed between adjacent antenna array elements; the antenna array elements will generate reflected field when the antenna array elements are made of good conductors and air gaps are formed between the adjacent antenna array elements. In the embodiment of the present invention, the antenna array elements are V-shaped slits so that cylindrical lens beam shaping effect will be achieved.

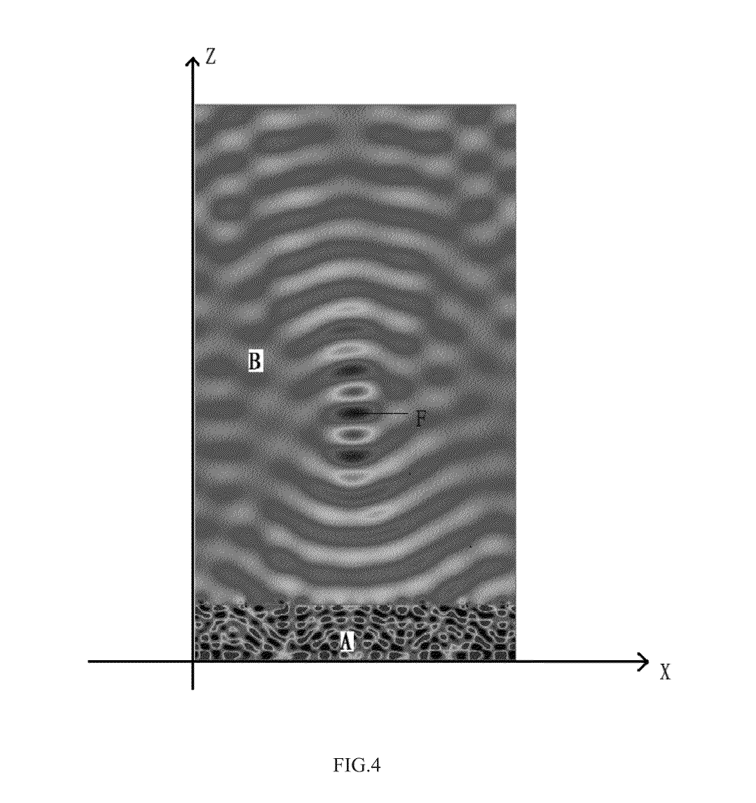

FIG. 4 shows transient amplitude spectrum of vertically polarized transmitted field excited by planar optical component according to the embodiment of the invention. The transient amplitude spectrum corresponds to the radiation field which is excited by the planar optical component with V-shaped antenna as shown in FIG. 1. Z-direction indicates the direction of light propagation and X-direction indicates the direction of column arrangement of the two-dimensional antenna array. The transmission field in area A shows amplitude distribution of the vertically polarized electric field of the planar optical component substrate, and the transmitted field in the area B shows the abnormal refraction field transmitted through the planar optical component. In addition, the transmission field in area A is formed by multiple reflections on the surfaces of the substrate and the metal; besides, the metal has a large area and little light can transmit through the planar optical component, so the radiation field in area A has a much larger amplitude than area B. By analyzing the amplitude distribution of the transmitted field in area B, the amplitude has its maximum at point F and will decrease along the Z-direction and X direction respectively, it becomes smaller around point F, which demonstrates that the light gradually converges during the propagation process until the point F which is the focal point and the distance between point F and the substrate is the focal length of for example 1.8 mm. Because the array elements of the planar optical component in 2D array arrangement remain unchanged along the direction of row arrangement, the amplitude of the transmission field is constant along the row direction. It means that the planar optical component plays a role of converging beam shaping as a cylindrical lens, the corresponding focal length of which is for example 1.8 mm, the diameter and height of which equal respectively to the width and height of the two-dimensional antenna array, both 8 mm for example, and the focal depth of which is 0.13 mm.

Furthermore, a planar optical component according to another embodiment of the present invention differs from the above embodiment in that the antenna array of the metal film is the anti-structured one of the V-shaped antenna array in the above embodiment; that is to say, the antenna array elements are good conductors and the air is arranged between adjacent elements. The planar optical component will generate a vertically polarized reflected field to achieve beam shaping effect of a cylindrical mirror, focal length, diameter, height and/or depth of focus of which are the same as corresponding parameters of the cylindrical lens of the embodiment described previously.

In the above embodiment of the present invention, the planar optical component having a V-shaped thin antenna array or the thin antenna array having rectangular antenna with opening may excite a radiation field which has a greater range of phase shifting, for example 360° and a larger amplitude than a linear antenna array. Furthermore, the planar diffractive optical component may generate a light perpendicular to the polarizing direction of the incident light, and moreover, it implements beam shaping. This fills the gap which hitherto existed in beam shaping method using existing optical components.

As described above, making use of characteristics of the modes that are excited by antenna of specific structure, single antenna structure and two-dimensional thin antenna array can be designed to produce a radiation field having particular amplitude, phase and polarization state, that is to say, the amplitude and the phase of the radiation field can be modulated by modulating structural parameters of the antenna array elements so that the planar optical component thus designed may achieve beam shaping effect in various band of spherical mirror, spherical lens, cylindrical lens or cylindrical mirror, and other types of optical elements. In the embodiment of the present invention, by modulating the length h and angle Δ of the V-shaped antenna, the amplitude and phase of the radiation field, which is excited by a light beam having specific wavelength and polarization state and being incident on the planar optical component, may be modulated. This method includes the following specific steps of:

401. Design an antenna structure having defined discrete phases, comprising:

Firstly, given the wavelength and polarizing direction of the incident light, determine constant structural parameters of the array element design, such as the width of the antenna, then by changing one or more variable structural parameters to design the values of the remaining variable parameters, thus achieving a plurality of sets of structural parameters corresponding to a plurality of antenna of different structures. The structure of antenna array elements may be V-shaped, rectangular having openings, and other structures.

In the present embodiment of the invention, the incident light is a terahertz light with a wavelength of 400 μm, the angles between the polarization direction and the defined vector ŝ and â of the V-shaped antenna element are both 45°; Assuming the antenna structure is a V-shaped structure, the arm width of two arms is determined to be 5 μm, then a set of suitable angles between the arms is selected as expected angle of the V-shaped structure; finally, a plurality of arm length values are designed. Thus, a plurality of V-shaped structures antenna are obtained.

Secondly, appropriate structures are selected according to characteristics of a preset radiation field; specifically, the radiation fields excited by the plurality of antennas are calculated; the antenna structure generating radiation near the resonance peak and of equal amplitude and determined discrete phase is chosen as array element for expected two-dimensional antenna array.

In the embodiment of the present invention, the principle of the selection is that the amplitudes of the cross-polarized radiation scattered by the antennas are nearly equal, with phases in π/4 increments, resulting in 4 kinds of different V-shaped antenna structures with different angles and arm lengths. The four kinds of V-shaped antennas and their mirror structure antennas will constitute a set of V-shaped antennas with discrete phase, which will be the array elements of two-dimensional thin antenna array in the next step. The mirror structure refers to a symmetric structure that mirrors the surface perpendicular to the polarization direction of incident light.

402. A two-dimensional thin antenna array will be designed by using as array elements the set of structure having defined discrete phases in step 401. The step 402 includes: presetting related parameters of the planar diffractive optical component to be designed, using the plurality of antennas mentioned in step 401 to arrange two-dimensional thin antenna arrays having preset shapes and sizes, wherein the preset two-dimensional thin antenna arrays may be square arrays, circular arrays, or arrays of other shapes.

In the embodiment of the present invention, the preset planar diffractive optical component is a cylindrical lens and the focal length of the cylindrical lens is set to be for example 2 mm; the preset two-dimensional thin antenna array is a square array and the number of rows and columns are both 40, the spacing of rows and columns are both 200 μm. To meet this objective, use the eight V-shaped antennas mentioned in step 401 to arrange a two-dimensional thin antenna array.

403. A planar optical component is constituted by the substrate and a metal film with the 2D thin antenna array structure designed in step 402. The step includes: selecting material and thickness of the substrate, selecting material and thickness of the metal film and constituting the planar optical component by the 2D antenna array mentioned in step 402. This planar diffractive optical component can be used to achieve full-band beam shaping effects of spherical lens, spherical mirror, cylindrical lens and cylindrical mirror, wherein the antenna array element may be slits and the gaps between adjacent antenna elements may be good conductors; alternatively, the antenna array elements may be made of good conductors and the gaps between adjacent antenna elements may be air. The substrate is made of material transparent in optical band of interest and the metal film may use noble metal such as gold, silver, copper and aluminum.

As shown in FIG. 1, in the embodiment of the present invention, the material of substrate is chosen to be silicon semiconductor and the thickness of the substrate is 500 μm; and, metal film is made of gold material and the thickness of the metal film is 200 nm. Planar optical components having convex lens effect may be constituted by the substrate and the metal films having 2D thin antenna array structure designed in step 402; the component has a focal length of 1.8 mm, which differs only 0.2 mm from preset focal length and is still in allowable error range. The embodiment of the present invention can get better results by further optimization of the algorithm.

To achieve the purpose of expected beam shaping, the embodiment of the present invention modulate the structural parameters of antenna array elements and further modulate the amplitude and phase of radiation field having vertical polarization states, which is excited by a beam having the specific wavelength and the polarization states incident on the planar diffractive optical component. The planar diffractive optical component according to the embodiments of the invention has little difference from excepted parameters, and can achieve optimum beam shaping effect, thus fills the gap which hitherto existed in beam shaping method using existing optical elements.

While specific embodiments have been shown and described with respect to the purposes, technical solutions and advantageous effects of the present invention, the embodiments described herein are exemplary only and are not limiting. Any modifications, equivalent substitutes and improvements in line with the spirit and principle of the present invention should not be excluded from the scope of protection of the present invention.

1. A planar optical component for full-band beam shaping, wherein the planar optical component comprising:
a substrate;
a metal film setting on the substrate and having a 2D thin antenna array structure, said 2D thin antenna array structure having a plurality of antenna array elements.

2. The planar optical component according to claim 1, wherein the planar optical component is used to implement the beam shaping of spherical lens, spherical mirror, cylindrical lens and cylindrical mirror.

3. The planar optical component according to claim 1, wherein the substrate is made of a material that is transparent to light.

4. The planar optical component according to claim 1, wherein the metal film is conductive.

5. The planar optical component according to claim 1, wherein the antenna array elements are slits, and good conductors are set between adjacent slits.

6. The planar optical component according to claim 1, wherein the antenna array structure has a V-shaped structure or a rectangular structure with an opening.

7. A method of designing a planar optical component for full-band beam shaping, the method comprising:
designing a set of structure having defined discrete phases;
designing a 2D thin antenna array using the set of structure having defined discrete phases as array elements; and
constituting the planar optical component by a metal film having 2D thin antenna arrays and a substrate.

8. The method according to claim 7, wherein the step of designing a set of structure having defined discrete phases comprises designing variable structural parameters of the antenna according to the wavelength, the polarization direction of the incident light and fixed structural parameters of the antenna, selecting a suitable structure based on characteristics of preset radiation field.

9. The method according to claim 7, wherein said set of structure having defined discrete phases excites a radiation field having a polarization state perpendicular to the direction of polarization of the incident light and having equal amplitudes and equal phase intervals.

10. The method according to claim 7, wherein the step of designing a 2D thin antenna array using the set of structure having defined discrete phases as array elements comprises presetting type and related parameters of the planar optical component, presetting shape and sizes of the 2D thin antenna arrays and designing configuration of 2D thin antenna arrays.

11. The planar optical component according to claim 1, wherein the antenna array elements are made of good conductors and air is filled between adjacent antenna array elements.
